(19) United States
(12) Patent Application Publication
(10) Pub. No.: US 2025/0210796 A1
(43) Pub. Date: Jun. 26, 2025

(54) BATTERY BOARD

(71) Applicant: GS Yuasa International Ltd., Kyoto-shi, Kyoto (JP)

(72) Inventors: Yosuke OKABE, Kyoto-shi, Kyoto (JP); Tsuyoshi HIDAKA, Kyoto-shi, Kyoto (JP); Tomohiro KAWAUCHI, Kyoto-shi, Kyoto (JP); Suguru MORIGUCHI, Kyoto-shi, Kyoto (JP); Sho YONEZAWA, Kyoto-shi, Kyoto (JP); Shota YAMAUCHI, Kyoto-shi, Kyoto (JP); Yoshihiro MASUDA, Ritto-shi, Shiga (JP); Keita HAMAKAWA, Ritto-shi, Shiga (JP)

(21) Appl. No.: 18/843,904

(22) PCT Filed: Mar. 8, 2023
(86) PCT No.: PCT/JP2023/008764

§ 371 Date: Mar. 13, 2025

(30) Foreign Application Priority Data
Mar. 10, 2022 (JP) 2022-036791

(51) Int. Cl. H01M 50/342; H01M 50/209; H01M 50/367; H01M 50/375

(52) U.S. Cl. CPC H01M 50/3425; H01M 50/209; H01M 50/367; H01M 50/375

(57) ABSTRACT

A battery board 900 incudes: an energy storage apparatus 1 that includes: at least one energy storage device 100 having a discharge valve 131; and a flow path that guides a fluid L discharged from the discharge valve 131 of the one energy storage device 100; and a housing 901 that houses the energy storage apparatus 1, wherein an opening enlarged portion 950 that opens or enlarges an opening area by receiving the fluid L is provided to a portion of the housing 901 that opposedly faces the flow path.

### CROSS REFERENCE TO RELATED APPLICATIONS

This application is a National Stage Application, filed under 35 U.S.C. § 371, of International Application No. PCT/JP2023/008764, filed Mar. 8, 2023, which international application claims priority to and the benefit of Japanese Application No. 2022-036791, filed Mar. 10, 2022; the contents of both of which are hereby incorporated by reference in their entirety.

### BACKGROUND

### Technical Field

The present invention relates to a battery board.

### Description of Related Art

JP-A-2020-161464, for example, discloses a battery board having a housing (frame) in which a plurality of energy storage apparatuses (battery modules) are housed.

### BRIEF SUMMARY

In a case where a problem occurs in an energy storage device provided to a predetermined energy storage apparatus so that a fluid (a gas, a liquid or a supercritical fluid) having a high temperature is generated, there is a concern that the inside of a housing is filled with the fluid so that other members (other normal energy storage apparatuses, control equipment and the like) are affected.

It is an object of the present invention to provide a battery board capable of suppressing a fluid from affecting other members even when the fluid is discharged from an energy storage apparatus.

In order to achieve the above object, a battery board according to one aspect of the present invention includes: an energy storage apparatus that includes: at least one energy storage device having a discharge valve; and a flow path that guides a fluid discharged from the discharge valve of the at least one energy storage device; and a housing that houses the energy storage apparatus, wherein an opening enlarged portion that opens or enlarges an opening area by receiving the fluid is provided to a portion of the housing that opposedly faces the flow path.

According to the battery board of the present invention, even when the fluid is discharged from the energy storage apparatus, it is possible to suppress the fluid from affecting other members.

### BRIEF DESCRIPTION OF THE FIGURES

FIG. 1 is a perspective view illustrating an external appearance of a battery board according to an embodiment.

FIG. 2 is a perspective view illustrating the external appearance of the battery board according to the embodiment.

FIG. 3 is a perspective view illustrating an external appearance of an energy storage apparatus according to the embodiment.

FIG. 4 is an exploded perspective view illustrating respective constitutional elements in a case where the energy storage apparatus according to the embodiment is disassembled.

FIG. 5 is a perspective view illustrating a configuration of an energy storage device according to the embodiment.

FIG. 6 is a plan view illustrating a schematic configuration of an opening enlarged portion according to the embodiment.

FIG. 7 is a cross-sectional view illustrating a schematic configuration of the opening enlarged portion according to the embodiment.

FIG. 8 is an explanatory view illustrating the flow of the opening enlarged portion when the opening enlarged portion is melted according to the embodiment.

FIG. 9 is a cross-sectional view illustrating the schematic configuration of an opening enlarged portion according to a modification 1.

FIG. 10 is a cross-sectional view illustrating an example of an opening mechanism according to a modification 2.

FIG. 11 is a cross-sectional view illustrating another example of the opening mechanism according to the modification 2.

### DETAILED DESCRIPTION OF VARIOUS EMBODIMENTS

A battery board according to one aspect of the present invention includes: an energy storage apparatus that includes: at least one energy storage device having a discharge valve; and a flow path that guides a fluid discharged from the discharge valve of the at least one energy storage device; and a housing that houses the energy storage apparatus, wherein an opening enlarged portion that opens or enlarges an opening area by receiving the fluid is provided to a portion of the housing that opposedly faces the flow path.

With such a configuration, in the housing, the opening enlarged portion is provided to the portion that corresponds to the flow path that guides the fluid (indicating a gas, a liquid, a supercritical fluid). Accordingly, when the fluid is discharged from the flow path of the energy storage apparatus, the opening enlarged portion receives the fluid and hence, the opening enlarged portion is opened or an opening area of the opening enlarged portion is enlarged. That is, the opening area of the opening enlarged portion is enlarged. As a result, the fluid (a gas, a liquid, an electrolyte solution in a supercritical fluid state, or a decomposition product that is (thermally) decomposed from a substance present in the energy storage device) jetted out from the flow path is discharged from the enlarged opening to the outside of the housing. Accordingly, it is possible to suppress heat, flame, or a fluid from being accumulated in the housing and hence, it is possible to suppress the energy storage apparatus from affecting other members (other energy storage apparatuses, control devices, and the like) in the housing.

A melting point of the opening enlarged portion may be lower than a melting point of a portion of the housing that differs from the opening enlarged portion.

According to such a configuration, a melting point of the opening enlarged portion is lower than a melting point of a portion of the housing that differs from the opening enlarged portion and hence, when the opening enlarged portion receives a fluid and/or a flame discharged from the flow path, the opening enlarged portion melts first to enlarge the opening area. That is, by merely using a simple technique where the material of the opening enlarged portion and the material of the sheet metal are made different from each other, it is possible to discharge a fluid and/or a flame jetted out from the flow path to the outside of the housing through the enlarged opening. It is preferable that the relationship of (a melting point of the opening enlarged portion) <(a temperature of a fluid and/or a flame discharged from the flow path)< “a melting point of the portion of the housing that differs from the opening enlarged portion” be satisfied.

A thickness of the opening enlarged portion may be set smaller than a thickness of the portion of the housing disposed adjacently to the opening enlarged portion.

With such a configuration, the thickness of the opening enlarged portion is thinner than the thickness of the portion disposed adjacently to the opening enlarged portion and hence, when the opening enlarged portion receives a fluid and/or a flame, the opening area of the opening enlarged portion is enlarged earlier than the portion disposed adjacently to the opening enlarged portion. That is, by merely adopting a simple method of making the thickness of the opening enlarged portion different from the thickness of the portion disposed adjacently to the opening enlarged portion, it is possible to discharge a fluid and/or a flame jetted out from the flow path to the outside of the housing from the enlarged opening.

The opening enlarged portion may have an opening mechanism that opens a portion of the housing by receiving the fluid.

With such a configuration, the opening mechanism of the opening enlarged portion opens a portion of the housing by receiving a fluid and/or a flame and hence, an opening area is enlarged. As a result, it is possible to discharge the fluid and/or the flame jetted out from the flow path to the outside of the housing from the enlarged opening.

At least one opening may be formed in the opening enlarged portion.

With such a configuration, at least one opening is formed in the opening enlarged portion and hence, ventilation can be performed by the opening in a state before a fluid and/or a flame is received (a normal operation time) whereby heat or a fluid accumulated in the housing can be released to the outside of the housing.

The plurality of energy storage apparatuses may be accommodated in the housing, and the opening enlarged portion may be provided to each of portions of the housing that opposedly faces flow paths of the plurality of energy storage apparatuses.

With such a configuration, the opening enlarged portions are disposed at the portions of the housing that opposedly face the flow paths of the plurality of energy storage apparatuses. Accordingly, even when a fluid and/or a flame is discharged from the flow path of any energy storage apparatus, the opening enlarged portion can receive the fluid and/or the flame and hence, the opening enlarged portion can enlarge its opening area. Accordingly, even when a fluid and/or a flame is jetted out from the flow path of any one of energy storage apparatuses, the fluid and/or the flame can be discharged to the outside of the housing through the enlarged opening.

The opening enlarged portions may be provided on a one-to-one basis with respect to the flow paths of the plurality of energy storage apparatuses.

With such a configuration, the plurality of opening enlarged portions are disposed on a one-to-one basis with respect to the flow paths of the plurality of energy storage apparatuses. Accordingly, it is possible to reduce an amount of material used for forming the opening enlarged portions. Further, the size of each opening enlarged portion can also be suppressed and hence, a thermal deformation amount of each opening enlarged portion during a normal operation time can be suppressed whereby a possibility that the energy storage apparatus is damaged can be reduced.

### Embodiments

Hereinafter, battery boards according to embodiments of the present invention (including a modifications thereof) will be described with reference to the drawings. All embodiments described hereinafter are comprehensive examples or specific examples. Numerical values, shapes, materials, constitutional elements, the arrangement positions and the connection modes of the constitutional elements, manufacturing steps, the order of the manufacturing steps, and the like in the embodiments described hereinafter are provided as examples, and they are not intended to limit the scope of the present invention. In the respective drawings, sizes and the like are not strictly illustrated. In the respective drawings, identical or substantially identical constitutional elements are given the same symbols.

In the description made hereinafter and in the drawings, an arrangement direction of a plurality of energy storage apparatuses arranged on one shelf plate of the battery board, an arrangement direction of a pair of electrode terminals (a positive electrode terminal and a negative electrode terminal) on one energy storage device, a direction that a pair of short side faces of a container of one energy storage device faces each other are defined as an X-axis direction. A direction that a front cover and a rear cover of the battery board face each other, an insertion direction that the energy storage devices are inserted into the shelf plate, an arrangement direction of the plurality of energy storage devices, and a direction that long side faces of the container of the energy storage device opposedly face each other are defined as a Y-axis direction. An arrangement direction of the plurality of shelf plates, an arrangement direction of the energy storage devices and bus bars, an arrangement direction of bodies and lid portions of the containers of the energy storage devices, an arrangement direction of the first support body and the second support body of the outer case support body, or a vertical direction is defined as a Z-axis direction. These X-axis direction, Y-axis direction, and Z-axis direction are the directions that intersect with each other (orthogonal to each other in the present embodiments). There may be a case where the Z-axis direction is not equal to the vertical direction depending on a use mode. However, in the description made hereinafter, for the sake of convenience of the description, the description is made by assuming the Z-axis direction as the vertical direction.

In the description made hereinafter, an X-axis plus direction indicates an arrow direction of the X-axis, and an X-axis minus direction indicates a direction opposite to the X-axis plus direction. In a case where the direction is simply referred to as the X-axis direction, the X-axis direction indicates both the X-axis plus direction and the X-axis minus direction or either one of the X-axis plus direction or the X-axis minus direction. The same goes for the Y-axis direction and the Z-axis direction. Expressions indicating the relative directions or the relative postures such as “parallel” or “orthogonal” also include cases where such directions or postures are not considered as such directions or such postures in a strict meaning of the terms. For example, “two directions are parallel to each other” not only means that such two directions are completely parallel, but also means that such two directions are substantially parallel. That is, “parallel” includes a difference of, for example, about several percents. Furthermore, in the following description, the expression “insulation” means “electrical insulation”.

### Description of Configuration of Battery Board

First, the configuration of a battery board 900 according to the present embodiment will be described. The battery board 900 is a stationary energy storage facility that stores electricity generated by, for example, wind power generation, solar power generation, or the like, and stably supplies the electricity to an external facility.

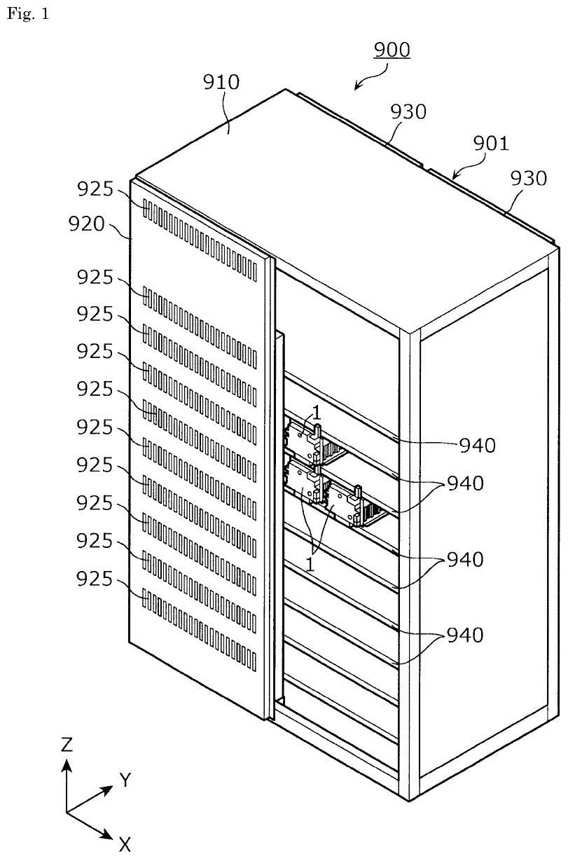

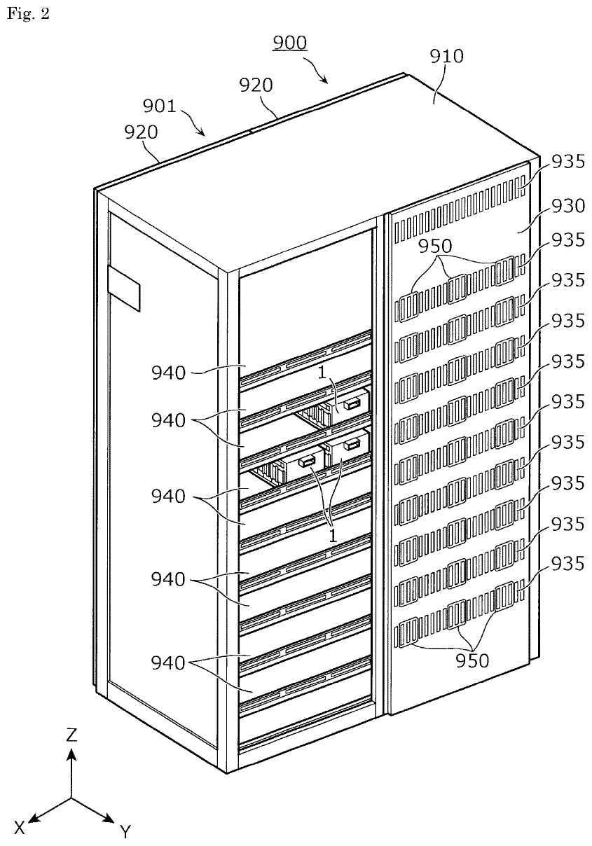

FIG. 1 and FIG. 2 are perspective views illustrating an external appearance of the battery board 900 according to the embodiment. FIG. 1 is a perspective view of the battery board 900 as viewed from a front side, and FIG. 2 is a perspective view of the battery board 900 as viewed from a rear side.

As shown in FIG. 1, the battery board 900 includes: a housing 901 made of metal; and a plurality of energy storage apparatuses 1. The housing 901 includes: a housing body 910, a pair of front covers 920; a pair of rear covers 930; and a plurality of shelf plates 940. In FIG. 1, out of the pair of front covers 920, one front cover 920 is not illustrated. In FIG. 2, out of the pair of rear covers 930, one rear cover 930 is not illustrated. FIG. 1 and FIG. 2 illustrate a case where three energy storage apparatuses 1 in total are installed on the plurality of shelf plates 940. However, the number of energy storage apparatuses 1 to be installed is not limited to three. In a portion of the battery board 900 that corresponds to one front cover 920, three energy storage apparatuses 1 can be installed on one shelf plate 940. The same goes for a portion of the battery board 900 that corresponds to the other front cover 920. That is, six energy storage apparatuses 1 can be installed on one shelf plate 940. In the housing body 910, nine shelf plates 940 are arranged in the Z-axis direction. Accordingly, 54 energy storage apparatuses 1 can be installed in the entire housing body 910.

The housing body 910 is, for example, a rectangular box made of metal, and an opening is formed on a front surface and a rear surface of the housing body 910 respectively. The opening on the front side of the housing body 910 is covered by a pair of front covers 920. The pair of front covers 920 is disposed side by side in the X-axis direction. The front covers 920 are mounted on a front portion of the housing body 910 in a state where the front covers 920 open and close an opening formed on the front side of the housing body 910. The opening formed on the rear side of the housing body 910 is covered by a pair of rear covers 930. The pair of rear covers 930 is disposed side by side in the X-axis direction. The rear covers 930 are mounted on a back portion of the housing body 910 in a state where the pair of rear covers 930 open and close the opening formed on the rear side of the housing body 910.

In the inside of the housing body 910, the plurality of shelf plates 940 are arranged in the Z-axis direction at a predetermined interval. The shelf plate 940 is a member that supports the plurality of energy storage apparatuses 1. Specifically, the shelf plate 940 is a plate body parallel to an XY plane, and the plurality of energy storage apparatuses 1 can be arranged and installed in the X axis direction with respect to each one shelf plate 940.

Although not illustrated, an electric circuit unit that is connected with the plurality of energy storage apparatuses 1 is disposed in the housing body 910. A wiring breaker (a circuit breaker), a control circuit and the like, for example, are accommodated in the electric circuit unit. The circuit breaker is disposed on a main circuit where a main current for charging and discharging the respective energy storage apparatuses 1 flows. The control circuit is connected to a circuit board unit 20 of each energy storage apparatus 1 by a signal line not illustrated in the drawing.

A plurality of slit groups 925 for ventilation are formed on the front cover 920, and a plurality of slit groups 935 are formed on the rear cover 930. Specifically, the plurality of slit groups 925 are arranged in the front cover 920 in the Z-axis direction. In one slit group 925, a plurality of slits each elongated in the Z-axis direction are arranged along the X-axis direction. The plurality of slit groups 935 are arranged in the rear cover 930 in the Z-axis direction. In one slit group 935, a plurality of slits each elongated in the Z-axis direction are arranged along the X-axis direction. The inside of the housing body 910 is ventilated by the plurality of slit groups 925 and the plurality of slit groups 935 so that heat or a fluid is not accumulated in the housing body 910. Each rear cover 930 includes a plurality of opening enlarged portions 950 in a state where that the plurality of opening enlarged portions 950 correspond to the respective energy storage apparatuses 1. The detailed configuration of the opening enlarged portion 950 will be described later.

Each slit of the slit group 925 and each slit of the slit group 935 have a narrow opening area so as to prevent a foreign substance (for example, a finger of a user or a worker) from entering the inside of the housing body 910. In the present embodiment, an opening width of the slit in the X-axis direction is appropriately narrowed.

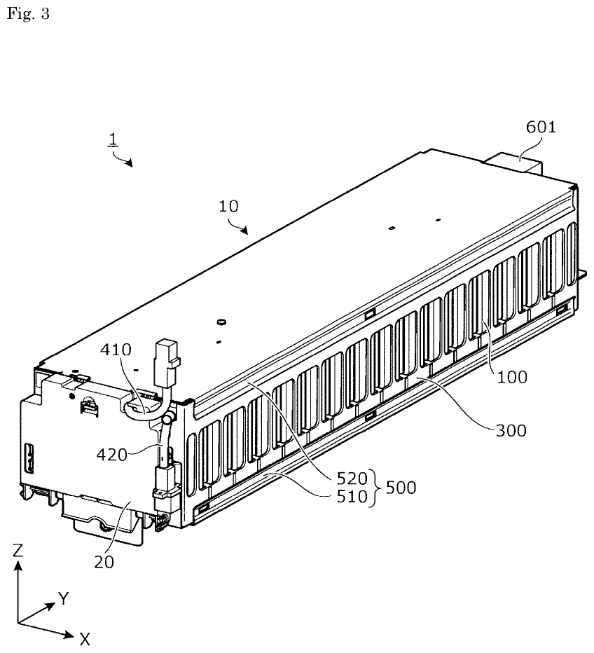

In the present embodiment, as described later, the energy storage apparatus 1 is disposed in the housing body 910 such that a discharge port 601 (see FIG. 3) of the energy storage apparatus 1 faces the rear cover 930. In the present embodiment, the opening enlarged portions 950 are formed on the rear cover 930. The opening enlarged portion 950 is configured to enlarge its opening area upon receiving a fluid jetted out from the discharge port 601 of the energy storage apparatus 1. With respect to the plurality of slit groups 935 formed on the rear cover 930, it is sufficient for the slit group 935 to have an opening area that can appropriately cool the energy storage apparatus 1 or the electric circuit unit in the battery board 900 during a normal operation of the battery board 900 (when a fluid is not jetted from the energy storage apparatus 1). An opening width of each slit in the X-axis direction is appropriately narrowed and hence, the strength of the battery board 900 itself and the strength of the rear cover 930 itself can be maintained.

On the other hand, when an abnormality occurs in the battery board 900 (for example, in a case where a fluid is jetted out from the certain energy storage apparatus 1), in order to reduce an adverse effect that a fluid jetted out from the energy storage apparatus 1 imparts to another energy storage apparatus 1 or the circuit unit disposed adjacently to the energy storage apparatus 1, it is necessary to release the fluid to the outside of the battery board 900 as soon as possible. The opening enlarged portion 950 disposed in a discharge path maintains an appropriate opening area when the battery board 900 is normally operated, and discharges a fluid with certainty when an abnormality occurs in the battery board 900. With such a configuration, it is possible to prevent the occurrence of a situation where a defect of a certain energy storage apparatus 1 affects other normal energy storage apparatuses 1 so that abnormality occurs in a chained manner.

The opening enlarged portion 950 may be disposed, for example, only at a position where a fluid discharged from the energy storage apparatus 1 is received. In a case where opening enlarged portion 950 is deformed, the opening enlarged portion 950 can be replaced without replacing the rear cover 930.

### Description of Configuration of Energy Storage Apparatus

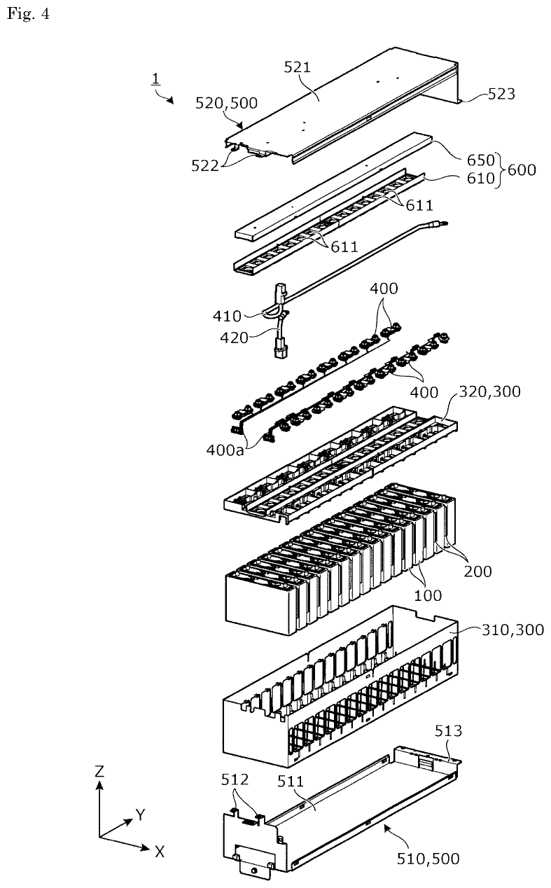

Next, the overall configuration of the energy storage apparatus 1 according to the embodiment will be described. FIG. 3 is a perspective view illustrating an external appearance of the energy storage apparatus 1 according to the embodiment. FIG. 4 is an exploded perspective view illustrating respective constitutional elements in a case where the energy storage apparatus 1 according to the embodiment is disassembled.

The energy storage apparatus 1 is an apparatus into which electricity can be charged from the outside and from which electricity can be discharged to the outside. In this embodiment, the energy storage apparatus 1 has an approximately rectangular parallelepiped shape. For example, the energy storage apparatus 1 is a battery module (an assembled battery) used in an electricity storage application, a power source application, or the like. To be more specific, the energy storage apparatus 1 is used as a battery or the like for driving a mobile body such as an automobile, a motorcycle, a watercraft, a ship, a snowmobile, an agriculture machine, a construction machine, an airplane, a railway vehicle for an electric railway, an artificial satellite, space probe or a railway vehicle for electric railway, or is used as a battery for starting an engine of the mobile body. As the above-described automobile, an electric vehicle (EV), a hybrid electric vehicle (HEV), a plug-in hybrid electric vehicle (PHEV), and an automobile that uses a fossils fuel (a gasoline, a light oil, a liquefied natural gas or the like) are exemplified. As an example of the railway vehicle for the electric railway described above, a train, a monorail, a linear motor car, and a hybrid train including both a diesel engine and an electric motor are exemplified. The energy storage apparatus 1 can also be used as a stationary battery or the like used as a home-use battery, a business use battery, or the like.

As illustrated in FIG. 3, the energy storage apparatus 1 includes: an energy storage unit 10; and the circuit board unit 20 mounted on the energy storage unit 10. The energy storage unit 10 has a substantially rectangular parallelepiped shape elongated in the Y-axis direction. The circuit board unit 20 is a device capable of monitoring a state of the energy storage devices 100 that the energy storage unit 10 includes and also capable of controlling the energy storage devices 100. A circuit board and the like are incorporated in the circuit board unit 20. In this embodiment, the circuit board unit 20 is a flat rectangular member mounted on an end of the energy storage units 10 in the longitudinal direction. That is, the circuit board unit 20 is mounted on a side surface of the energy storage units 10 on the Y-axis minus direction side. Cables 410 and 420 are connected to the energy storage unit 10.

As illustrated in FIG. 4, the energy storage unit 10 includes a plurality of energy storage devices 100, a plurality of spacers 200, a resin outer case 300, a plurality of bus bars 400, an outer case support body 500, and a discharge member 600.

The energy storage device 100 is a battery cell of a secondary battery capable of charging and discharging electricity, and more specifically, is a battery cell of a nonaqueous electrolyte secondary battery such as a lithium ion secondary battery. The energy storage device 100 has a flat rectangular parallelepiped shape (prismatic shape). In this embodiment, sixteen pieces of energy storage devices 100 are arranged side by side in the Y-axis direction. The size and the shape of the energy storage devices 100, the number of the arranged energy storage devices 100, and the like are not limited, and for example, only one energy storage device 100 may be arranged. The energy storage device 100 is not limited to a nonaqueous electrolyte secondary battery. The energy storage device 100 may be a secondary battery other than the nonaqueous electrolyte secondary battery, or may be a capacitor. The energy storage device 100 is not necessarily a secondary battery, and may be a primary battery that allows a user to use stored electricity even when the user does not charge the battery. Further, the energy storage device 100 may be a battery that uses a solid electrolyte. The energy storage device 100 may be a pouch-type energy storage device. The detailed configuration of the energy storage device 100 is described later.

The spacer 200 is a plate-like and rectangular member which is disposed side by side with the energy storage device 100 in the Y-axis direction, and provides heat insulation and/or electric insulation between the energy storage device 100 and the other members. The spacer 200 is a heat insulating plate or an electric insulating plate which is disposed in the Y-axis plus direction or the Y-axis minus direction of the energy storage devices 100 and provides heat insulation and/or electric insulation between the energy storage devices 100. The spacer 200 is formed of a member having a heat insulating property such as a dammer material, or a member having an electric insulating property such as any resin material that can be used for resin outer case 300 described later.

The resin outer case 300 is a member that is disposed outside the plurality of energy storage devices 100 and the plurality of spacers 200 and constitutes a housing (an outer shell of the energy storage unit 10) that covers the plurality of energy storage devices 100 and the like. To be more specific, the resin outer case 300 is disposed on both sides of the plurality of energy storage devices 100 in the Z-axis direction so as to sandwich the plurality of energy storage devices 100 and the plurality of spacers 200 in the Z-axis direction, and covers both end portions of the plurality of energy storage devices 100 and the like in the Z-axis direction. With such a configuration, the resin outer case 300 fixes the plurality of energy storage devices 100 and the plurality of spacers 200 at a predetermined position by collectively holding the plurality of energy storage devices 100 and the plurality of spacers 200 thus protecting the resin outer case 300 from an impact or the like.

The resin outer case 300 is formed of an insulating member such as polycarbonate (PC), polypropylene (PP), polyethylene (PE), polystyrene (PS), a polyphenylene sulfide resin (PPS), polyphenylene ether (PPE (including modified PPE)), polyethylene terephthalate (PET), polybutylene terephthalate (PBT), polyether ether ketone (PEEK), tetrafluoroethylene-perfluoroalkyl vinyl ether (PFA), polytetrafluoroethylene (PTFE), polyether sulfone (PES), polyamide (PA), an ABS resin, or a composite material thereof, or an insulation-coated metal or the like. The resin outer case 300 formed as described above prevents the energy storage devices 100 and the like from coming into contact with an external metal member and the like. Provided that the resin outer case 300 adopts the configuration where the electric insulation property of the energy storage devices 100 and the like is secured, the resin outer case 300 may be formed using a conductive material such as metal or the like.

The resin outer case 300 includes: an outer case body 310 constituting a body of the resin outer case 300; and a bus bar frame 320 constituting a lid of the resin outer case 300. The outer case body 310 and the bus bar frame 320 may be formed using the same material, or may be formed using different materials.

The outer case body 310 is a bottomed rectangular cylindrical housing where the entire surface of a face in the Z-axis plus direction is opened, and a face in the Z-axis minus direction is closed. To be more specific, the outer case body 310 is a box-shaped body elongated in the Y-axis direction where the plurality of energy storage devices 100 and the plurality of spacers 200 are accommodated in a state where the plurality of energy storage devices 100 and the plurality of spacers 200 are arranged in the Z-axis minus direction.

The bus bar frame 320 is a member having a box shape (a flat and substantially rectangular parallelepiped shape) elongated in the Y-axis direction that is disposed in the Z-axis plus direction of the plurality of energy storage devices 100 and the plurality of spacers 200, and is mounted on the plurality of energy storage devices 100. The bus bar frame 320 is disposed between a second support body 520 of the outer case support body 500 described later and the energy storage devices 100 and hence, the bus bar frame 320 can also be referred to as an inner lid of the energy storage unit 10. The bus bar frame 320 can also be referred to as a bus bar holder or a bus bar plate. In the present embodiment, the bus bar frame 320 provides insulation between the bus bars 400 and other members, and performs restriction of the positions of the bus bars 400, and the like. To be more specific, the bus bar frames 320 are mounted on the plurality of energy storage devices 100, are positioned with respect to the plurality of energy storage devices 100, and the plurality of bas bars 400 are positioned with respect to the bas bar frame 320. With such a configuration, the respective bus bars 400 are positioned with respect to the plurality of energy storage devices 100, and are joined to electrode terminals 140 that the plurality of energy storage devices 100 include.

The bus bars 400 are each formed of a rectangular plate-like member. The bas bars 400 are disposed on the plurality of energy storage devices 100, and electrically connect the electrode terminals 140 of the plurality of energy storage devices 100 to each other. In the present embodiment, the bus bar 400 and the electrode terminal 140 are connected (joined to each other) by bolt fastening. However, the bus bar 400 and the electrode terminal 140 may be connected (joined to each other) by welding or the like. The bus bar 400 is formed of a conductive member made of metal such as aluminum, an aluminum alloy, copper, a copper alloy, or nickel, a combination thereof, or a conductive member made of a material other than metal, or the like. In the present embodiment, the bus bars 400 connect the 16 energy storage devices 100 in series by connecting the electrode terminals 140 of the energy storage devices 100 disposed adjacently to each other. However, the connection mode of the energy storage devices 100 is not limited to the above, and the series connection and the parallel connection may be combined in any desired manner.

A detection line 400a is connected to the bus bars 400. The detection line 400a is an electric wire (also referred to as a communication cable, a control cable, a communication line, and a control line.) for measuring a voltage of the energy storage device 100, for measuring a temperature of the energy storage device, or for taking a voltage balance between the energy storage devices 100. The detection line 400a is connected to the board unit 20, and transmits information such as voltages and temperatures of the energy storage devices 100 to the board unit 20.

By connecting the cables 410 and 420 to the electrode terminals 140 of the energy storage devices 100 located at both ends in the Y-axis direction of the plurality of energy storage devices 100, electricity can be charged to the energy storage apparatuses 1 from the outside, or electricity can be discharged to the outside from the energy storage apparatuses 1. The cables 410 and 420 are positive and negative pole electric wires (power supply cables) through which a current (main current) for charging and discharging the energy storage apparatus 1 (energy storage device 100) flows.

The outer case support body 500 is a member which supports and protects (reinforces) the resin outer case 300. The outer case support body 500 includes: a first support body 510 that forms a body of the outer case support body 500; and a second support body 520 that forms a lid body of the outer case support body 500.

The first support body 510 and the second support body 520 are made of a material having higher thermal conductivity than the outer case body 310. Specifically, the outer case support body 500 is formed of a member made of metal such as stainless steel, aluminum, an aluminum alloy or iron, or a plated steel plate. The first support body 510 and the second support body 520 may be made of the same material, or may be made of different materials.

The first support body 510 is a metal plate on which the outer case body 310 is mounted, and supports the outer case body 310 from below (in the Z-axis minus direction). The first support body 510 has a bottom portion 511 and connecting portions 512 and 513. The bottom portion 511 is a flat plate-like and rectangular portion that forms a bottom portion of the energy storage unit 10, and extends in parallel to the XY plane and in the Y axis direction. The bottom portion 511 is disposed in the Z-axis minus direction of the outer case body 310.

The connecting portion 512 is a plate-like portion that is erected in the Z-axis plus direction from an end portion of the bottom portion 511 in the Y-axis minus direction, and projects in the Y-axis minus direction. The connecting is connected to the second support body 520. The connecting portion 513 is a plate-like portion that is erected in the Z-axis plus direction from a Y-axis plus direction end portion of the bottom portion 511 and projects in the Y-axis plus direction. The connecting is connected to the second support body 520.

The second support body 520 is a metal plate that presses and supports the bus bar frame 320 from above the bus bar frame 320 (in the Z-axis plus direction). The second support body 520 includes a top surface portion 521 and connecting portions 522 and 523. The top surface portion 521 is a flat plate-like and rectangular portion which forms an upper surface portion (an outer lid) of the energy storage unit 10, and extends in parallel to the XY plane and in the Y axis direction. The top surface portion 521 is disposed in the Z axis plus direction of the bus bar frame 320. The connecting portion 522 is a portion that extends in the Z-axis minus direction from a Y-axis minus direction end portion of top surface portion 521, and protrudes in the Y-axis minus direction. The connecting portion 522 is connected to the connecting portion 512 of the first support body 510. The connecting portion 523 is a portion that extends in the Z-axis minus direction from the Y-axis plus direction end portion of the top surface portion 521 and protrudes in the Y-axis plus direction. The connecting portion 523 is connected to the connecting portion 513 of first support body 510.

In this manner, the first support body 510 and the second support body 520 are configured to be fixed to each other by connecting (joining) the connecting portions 512 and 513 and the connecting portions 522 and 523 by screwing or the like in a state where the outer case body 310 and the bus bar frame 320 are sandwiched between the first support body 510 and the second support body 520 in the Z axis direction. With such a configuration, the outer case support body 500 supports (holds) the resin outer case 300.

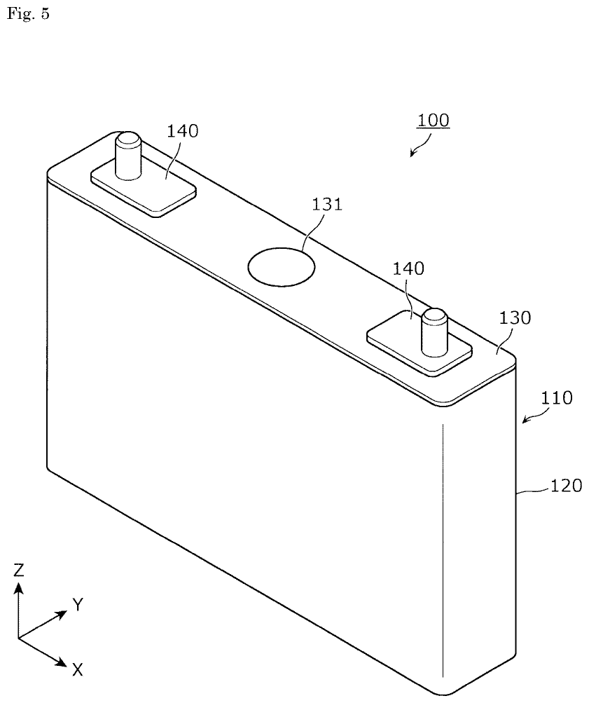

The discharge member 600 is disposed above the bus bar frame 320 so as to be disposed on the discharge valves 131 (see FIG. 5) of the respective energy storage devices 100, and forms a flow path for fluids discharged from the respective discharge valves 131. One end portion of the discharge member 600 in the Y-axis plus direction forms the discharge port 601 through which a gas is discharged. The discharge port 601 is exposed from the connecting portion 523 of the second support body 520 (see FIG. 3). To be more specific, the discharge member 600 includes: a body portion 610 that is opened upward (in the Z-axis plus direction); and a lid member 650 that closes an opened portion of the main body portion 610. A plurality of ventilation holes 611 that communicate with the discharge valves 131 of the respective energy storage devices 100 are formed in a bottom portion of the body portion 610. An internal space formed between the body portion 610 and the lid member 650 serves as a flow path for a fluid.

### Description of Energy Storage Device

Next, the configuration of the energy storage device 100 is described in detail. FIG. 5 is a perspective view illustrating the configuration of the energy storage device 100 according to the embodiment. To be more specific, FIG. 5 illustrates, in an enlarged manner, an external appearance of one energy storage device 100 out of the plurality of energy storage devices 100 illustrated in FIG. 4. All of the plurality of energy storage devices 100 have substantially the same configuration. Accordingly, the configuration of one energy storage device 100 will be described in detail below.

As illustrated in FIG. 5, the energy storage device 100 includes: a container 110; and a pair of (positive and negative) electrode terminals 140. An electrode assembly, a pair of (positive and negative) current collectors, an electrolyte solution (a nonaqueous electrolyte) and the like are accommodated in the container 110. However, the illustration of these constitutional elements is omitted. A kind of the electrolyte solution is not particularly limited provided that the performance of the energy storage device 100 is not impaired, and various kinds of electrolyte solutions can be selected. The energy storage device 100 includes insulating gaskets that provide insulation and sealing between the container 110, the electrode terminals 140 and the current collectors. However, the illustration of these gaskets is also omitted.

The energy storage device 100 may further include, besides the constitutional elements described above, the spacers disposed on the sides of the electrode assembly or above and below the electrode assembly, an insulating film that wraps the electrode assembly and the like. An insulating film (such as a shrink tube) that covers an outer surface of the container 110 may be disposed surrounding a periphery of the container 110. The material of the insulating film is not particularly limited provided that insulating property required for the energy storage device 100 can be secured. As such a material, a resin having insulating property such as PC, PP, PE, PPS, PET, PBT and an ABS resin, an epoxy resin, Kapton (registered trademark), Teflon (registered trademark), silicon, polyisoprene and polyvinyl chloride and the like are exemplified.

The container 110 is a case having a rectangular parallelepiped shape (a prismatic shape or a box shape). The container 110 includes: a container body 120 that has an opening; and a lid portion 130 that closes the opening of the container body 120. The container body 120 is a member that forms a body of the container 110 and has a bottomed rectangular cylindrical shape. The opening is formed in the container body 120 in a Z-axis plus direction. The lid portion 130 is a rectangular plate-like member which forms a lid body of the container 110. The lid portion 130 is disposed in an elongated manner in the X-axis direction in the Z-axis plus direction of the container body 120. On the container 110 (the lid portion 130), a discharge valve 131 that releases a pressure in the container 110 when such a pressure becomes excessively large, a solution filling portion (not illustrated in the drawings) through which the container 110 is filled with an electrolyte solution, and the like are mounted. The material of the container 110 (the container body 120 and the lid portion 130) is not particularly limited. For example, the container 110 may be made of metal that is weldable (joinable) such as stainless steel, aluminum, an aluminum alloy, iron, or a plated steel plate. A resin can be also used as the material of the container 110. The container 110 has the structure where the inside of the container 110 is sealed. Such sealed structure is obtained by accommodating the electrode assembly and the like in the container body 120 and, thereafter, by joining the container body 120 and the lid portion 130 to each other by welding or the like.

The electrode terminals 140 are terminal members (a positive terminal and a negative terminal) of the energy storage device 100 disposed on the lid portion 130. The terminals 140 are electrically connected to a positive electrode plate and a negative electrode plate of the electrode assembly via the current collectors. The electrode terminals 140 are metal-made members that are provided for discharging electricity stored in the electrode assembly to an external space outside the energy storage device 100, and for charging electricity into an internal space in the energy storage device 100 so as to store electricity in the electrode assembly. The electrode terminals 140 are made of aluminum, an aluminum alloy, copper, a copper alloy, or the like.

The electrode assembly is an energy storage element (a power generating element) formed by stacking a positive electrode plate, a negative electrode plate, and a separator to each other. The positive electrode plate is formed such that a positive active material layer is formed on a positive substrate layer that is a current collecting foil made of metal such as aluminum or an aluminum alloy. The negative electrode plate is formed such that a negative active material layer is formed on a negative substrate layer that is a current collecting foil made of metal such as copper or a copper alloy. As an active material used for forming the positive active material layer and an active material used for forming the negative active material layer, known materials can be appropriately used provided that these materials can occlude and discharge lithium ions. As the separator, a microporous sheet, a nonwoven fabric or the like made of a resin can be used. In the embodiment, the electrode assembly is formed by stacking the plates (the positive electrode plates and the negative electrode plates) in the Y-axis direction. The electrode assembly may be an electrode assembly in any form such as a winding-type electrode assembly formed by winding plates (a positive electrode plate and a negative electrode plate), a layered-type (stacking-type) electrode assembly formed by stacking a plurality of flat-plate-shaped plates, or a bellows-type electrode assembly formed by folding plates in a bellows shape.

The current collectors (the positive electrode current collector and the negative electrode current collector) are members having conductivity and are electrically connected to the electrode terminals 140 and the electrode assembly. The positive electrode current collector is made of aluminum, an aluminum alloy or the like substantially in the same manner as the positive substrate layer of the positive electrode plate. The negative electrode current collector is made of copper, a copper alloy, or the like substantially in the same manner as the negative substrate layer of the negative electrode plate.

### Description of Opening Enlarged Portion

Next, each opening enlarged portion 950 provided to the rear cover 930 will be described. Since each of the opening enlarged portions 950 basically has the same structure, only one opening enlarged portion 950 will be described as an example.

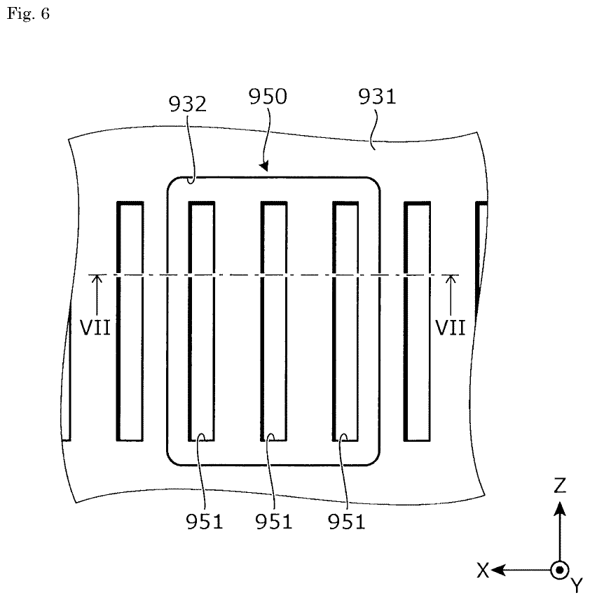

FIG. 6 is a plan view illustrating a schematic configuration of the opening enlarged portion 950 according to the embodiment. FIG. 7 is a cross-sectional view illustrating a schematic configuration of the opening enlarged portion 950 according to the embodiment. FIG. 7 is a cross-sectional view taken along line VII-VII of FIG. 6.

As illustrated in FIG. 6 and FIG. 7, the opening enlarged portion 950 is integrally attached to the sheet metal 931 that forms the rear cover 930. Specifically, the sheet metal 931 has an attaching hole portion 932 to which the opening enlarged portion 950 is attached, and opening enlarged portion 950 engages with the attaching hole portion 932 by fitting engagement. The opening enlarged portion 950 is integrally attached to the sheet metal 931 by being bonded or welded to an inner peripheral surface of the attaching hole portion 932. Three openings 951 that are slits included in the slit group 935 are formed in the opening enlarged portion 950.

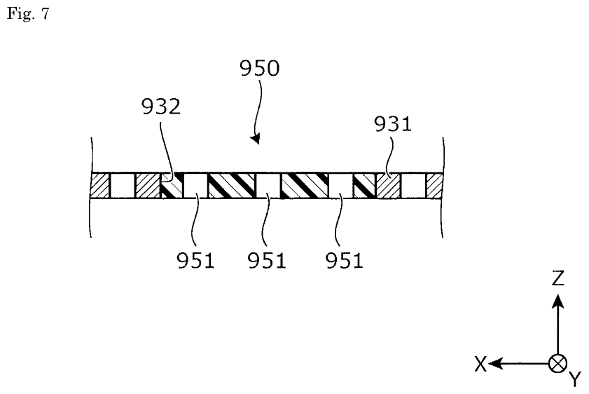

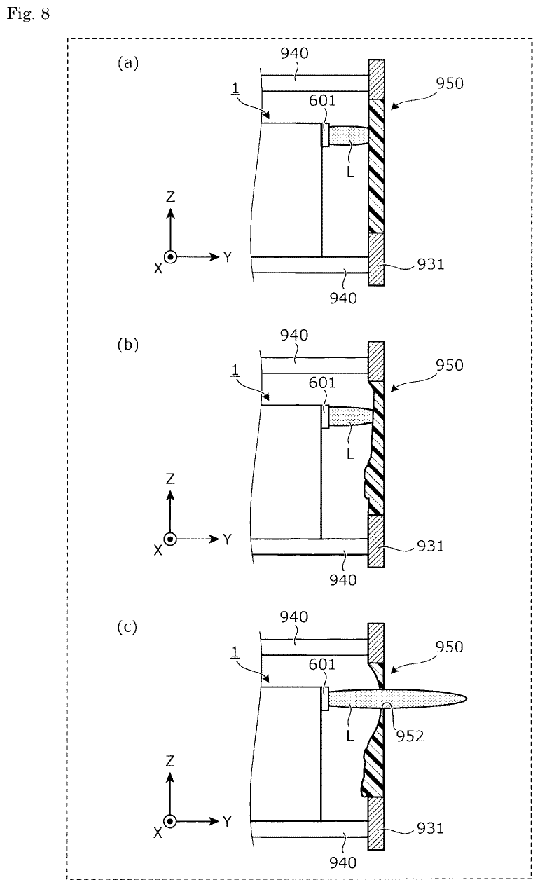

The opening enlarged portion 950 is disposed at a position that opposedly faces the discharge port 601 of the energy storage apparatus 1 (see FIG. 8). That is, the opening enlarged portion 950 opposedly faces the discharge port 601 that is a portion of the flow path of a fluid. Accordingly, the opening enlarged portion 950 is exposed to a fluid L discharged from the discharge port 601. The opening enlarged portion 950 is formed of a resin plate having substantially the same thickness as a portion of the sheet metal 931 disposed adjacently to the attaching hole portion 932. Accordingly, a melting point of the opening enlarged portion 950 is lower than a melting point of the sheet metal 931 that is a portion of the rear cover 930 different from the opening enlarged portion 950. In a case where the opening enlarged portion 950 and the sheet metal 931 are exposed to a high-temperature fluid L discharged from the discharge port 601, the opening enlarged portion 950 melts faster than the sheet metal 931.

As a resin that is used for forming the opening enlarged portion 950, any resin can be adopted provided that the resin has a lower melting point than the sheet metal 931 and is soluble by heat of the fluid discharged from the energy storage device 100. From a viewpoint of visibility of the inside of the housing 901, a transparent acrylic resin is preferably adopted. Furthermore, in order to suppress the generation of an odor at the time of melting, it is preferable to use a resin that contains neither sulfur nor nitrogen.

The flow of the opening enlarged portion 950 when the opening enlarged portion 950 is melted will be described below. FIG. 8 is an explanatory view illustrating the flow of the opening enlarged portion 950 when the opening enlarged portion 950 is melted according to the embodiment. In FIG. 8, the sheet metal 931 of the rear cover 930 and the opening enlarged portion 950 are illustrated in a cross-sectional view.

First, as illustrated in FIG. 8(a), when the fluid L starts to be discharged from the discharge port 601, the opening enlarged portion 950 is exposed to the fluid L and is heated. Although not illustrated in FIG. 8, the fluid L is discharged from the slit group 935 to the outside of the housing 901.

As the heating of the opening enlarged portion 950 progresses, the opening enlarged portion 950 gradually starts to melt (see FIG. 8(b)), and finally a new opening 952 that differs from the opening 951 is formed in the opening enlarged portion 950 (see FIG. 8(c))). That is, an opening area of the opening enlarged portion 950 as a whole is enlarged. The fluid L is also released from the opening 952, it is possible to suppress heat or the fluid from being accumulated in the housing 901.

In the present embodiment, the case is described where the fluid L is discharged from the discharge port 601. However, there is a case where a flame caused by the fluid L is discharged from the discharge port 601. However, also in this case, the opening area of the opening enlarged portion 950 is enlarged in the same manner as the flow described above.

### Description of Advantageous Effects

As described above, according to the battery board 900 of the present embodiment, in the housing 901, the opening enlarged portion 950 is provided to the portion that corresponds to the discharge port 601 for discharging the fluid L in the energy storage apparatus 1. Accordingly, when the fluid L is discharged from the discharge port 601 of the energy storage apparatus 1, the opening area of the opening enlarged portion 950 is enlarged by receiving the fluid L. That is, the opening area of the opening enlarged portion 950 as a whole is enlarged. As a result, the fluid L jetted out from the discharge port 601 (a gas, a liquid, an electrolyte solution in a supercritical fluid state, or a decomposition product that is (thermally) decomposed from a substance present in the energy storage device) and the flame caused by the fluid L are discharged from the enlarged openings (the opening 951 and the opening 952) to the outside of the housing 901. Accordingly, it is possible to suppress the accumulation of heat in the housing 901 and hence, it is possible to suppress the energy storage apparatus 1 from thermally affecting other members (other energy storage apparatuses 1, the control devices and the like) in the housing 901.

A melting point of the opening enlarged portion 950 is lower than a melting point of the portion (the sheet metal 931) of the housing 901 different from the opening enlarged portion 950. Accordingly, when the opening enlarged portion 950 receives the fluid L and/or a flame discharged from the discharge port 601, the opening enlarged portion 950 melts first to enlarge its opening area. That is, by merely using a simple technique where the material of the opening enlarged portion 950 and the material of the sheet metal 931 are made different from each other, it is possible to discharge a fluid and/or a flame jetted out from the discharge port 601 to the outside of the housing 901 through the enlarged opening (the openings 951 and the opening 952).

At least one opening 951 is formed in the opening enlarged portion 950 and hence, ventilation can be performed by the opening 951 in a state before a fluid and/or a flame is received (a normal operation time) whereby heat or a fluid accumulated in the housing 901 can be released to the outside of the housing 901.

The opening enlarged portions 950 are disposed at the portions of the housing 901 that opposedly face the discharge ports 601 of the plurality of energy storage apparatuses 1. Accordingly, even when a fluid L and/or a flame is discharged from the discharge port 601 of any energy storage apparatus 1, the opening enlarged portion 950 can receive the fluid L and/or the flame and hence, the opening enlarged portion 950 can enlarge its opening area. Accordingly, even when a fluid L and/or a flame is jetted out from the discharge port 601 of any one of energy storage apparatuses 1, the fluid L and/or the flame can be discharged to the outside of the housing 901 through the enlarged opening (the opening 951 and the opening 952).

The plurality of opening enlarged portions 950 are disposed on a one-to-one basis with respect to the discharge ports 601 of the plurality of energy storage apparatuses 1. Accordingly, it is possible to reduce an amount of material used for forming the opening enlarged portions 950. Further, the size of each opening enlarged portion 950 can also be suppressed. Accordingly, a thermal deformation amount of each opening enlarged portion 950 in a normal operation state can be suppressed and hence, a possibility that the opening enlarged portion 950 is damaged can be reduced.

### Description of Modifications

Hereinafter, respective modifications of the above-described embodiment will be described. In the following description, constitutional elements identical with the constitutional elements in the above-described embodiment or other modifications are denoted by the same reference numerals, and the description of these constitutional elements may be omitted.

### Modification 1

In the above-described embodiment, the case has been exemplified where a thickness of the opening enlarged portion 950 is substantially equal to a thickness of the portion of the sheet metal 931 disposed adjacently to the attaching hole portion 932. However, the thickness of the opening enlarged portion may be formed smaller than the thickness of the portion of the sheet metal 931 disposed adjacently to the opening enlarged portion.

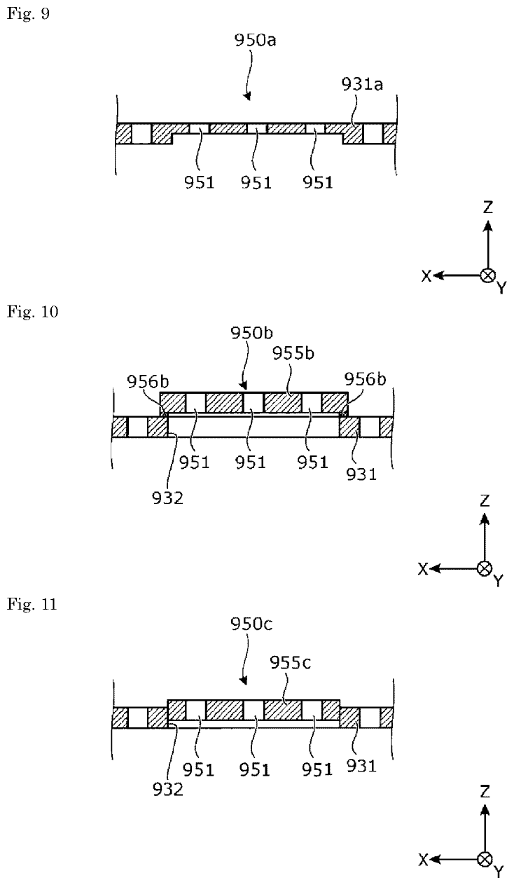

FIG. 9 is a cross-sectional view illustrating the schematic configuration of an opening enlarged portion 950a according to a modification 1. FIG. 9 is a view that corresponds to FIG. 7. As illustrated in FIG. 9, an opening enlarged portion 950a is formed of a sheet metal 931a. A thickness of the opening enlarged portion 950a is set smaller than a thickness of a portion of the sheet metal 931a disposed adjacently to the opening enlarged portion 950a. With such a configuration, when the opening enlarged portion 950a receives a fluid L heated to a high temperature, the opening enlarged portion 950a melts earlier than the portion disposed adjacently to the opening enlarged portion 950a and hence, an opening area of the opening enlarged portion 950a is enlarged. That is, by merely using a simple technique where the thickness of the opening enlarged portion 950a and the thickness of the portion disposed adjacently to the opening enlarged portion 950a are made different from each other, it is possible to discharge a fluid and/or a flame jetted out from a flow path to the outside of the housing 901 through the enlarged opening.

In this modification, the opening enlarged portion 950a formed using the sheet metal 931a is exemplified. However, the opening enlarged portion may be formed using a resin in the same manner as the above-described embodiment. Also in this case, the opening enlarged portion can be melted and opened early and hence, such a configuration is preferable.

### Modification 2

In the above embodiment, the case where the opening enlarged portion 950 is melted by the fluid L heated to a high temperature to increase the opening area has been exemplified. However, the opening enlarged portion may have an opening mechanism that opens a portion of the housing by receiving a fluid.

FIG. 10 is a cross-sectional view illustrating an example of an opening mechanism according to a modification 2. FIG. 10 is a view that corresponds to FIG. 7. As illustrated in FIG. 10, an opening enlarged portion 950b includes: a metal body plate 955b that covers an attaching hole portion 932 of a sheet metal 931; and a joining portion 956b made of a resin that joins the sheet metal 931 to the metal body plate 955b. When the metal body plate 955b receives a fluid L heated to a high temperature, the joining portion 956b is melted by heat and hence, the metal body plate 955b is separated from the sheet metal 931 whereby an opening area is enlarged. That is, the joining portion 956b forms an example of the opening mechanism.

FIG. 11 is a cross-sectional view illustrating another example of the opening mechanism according to the modification 2. FIG. 11 is a view that corresponds to FIG. 10. As illustrated in FIG. 11, an opening enlarged portion 950c has a metal body plate 955c that engages with an attaching hole portion 932 of a sheet metal 931 by fitting engagement. When the metal body plate 955c receives a fluid L jetted out from a discharge port 601 of an energy storage apparatus 1, the metal body plate 955c is blown off from the attaching hole portion 932 by a force generated by the jetted-out fluid L and hence, an opening area is enlarged. That is, the metal body plate 955c that engages with the attaching hole portion 932 by fitting engagement forms an example of the opening mechanism.

As the opening mechanism, a structure may be adopted where a shape memory alloy or spring is used, and an open area of an opening enlarged portion is expanded by the thermal deformation of the shape memory alloy or spring.

### Miscellaneous

The battery board 900 according to the embodiments of the present invention has been described heretofore. However, the present invention is not limited to the embodiment described above. That is, the embodiments disclosed this time are illustrative in all aspects, and are not limitative. The present invention includes all alterations which fall within the scope of claims or are considered equivalent to the present invention called for in claims.

For example, in the above-described embodiment, the case where opening enlarged portion 950 has opening 951 in advance has been exemplified. However, the opening enlarged portion may be closed as a whole before receiving the fluid. In this case, the opening enlarged portion is melted and opened by receiving the fluid heated to a high temperature. That is, also in this case, the opening area of the opening enlarged portion is enlarged.

In the above-mentioned embodiment, by way of example, the opening enlarged portion 950 is disposed in the portion of the housing 901 which opposedly faces the discharge port 601 which forms a part of the flow path of the energy storage apparatus 1. However, there also exist some energy storage apparatuses that each do not include a discharge port. With respect to such energy storage apparatuses, in the housing, the opening enlarged portion may be provided at a portion that opposedly faces the flow path in the energy storage apparatus. More specifically, a portion that can be opened by a fluid is provided in the flow path of the energy storage apparatus, and the opening enlarged portion may be provided at a portion of the housing that opposedly faces the portion that can be opened by the fluid. Even in the energy storage apparatus 1 that is not provided with the discharge member 600, it is sufficient that a structure is adopted where at least a portion of the fluid discharged from the energy storage device 100 flows and is discharged to the outside of the energy storage apparatus 1 (or a structure having the same function), and the opening enlarged portion is disposed at the portion of the housing that opposedly faces the fluid discharged from the energy storage apparatus 1.

In the above-mentioned embodiment, the case is exemplified where the opening enlarged portion 950 is formed using a resin. However, the opening enlarged portion may be formed using metal having a melting point lower than a melting point of the sheet metal that forms the housing. Besides the above-mentioned configuration, the opening enlarged portion may be formed using a material which is more fragile than a sheet metal with respect to a fluid discharged from the energy storage device. As other examples of such a material, wood, paper, cloth, and the like are named. Further, the opening enlarged portion may be formed using a material that is deformed and melted due to a chemical reaction with an electrolyte contained in a fluid.

In the above-mentioned embodiment, the opening enlarged portion 950 that is deformed by receiving a fluid L and enlarges an opening area is exemplified. However, the configuration may be adopted where the discharging of a fluid from the energy storage apparatus is detected, and an opening enlarged portion is controlled based on a detection result thus increasing an opening area of the opening enlarged portion. In this case, the battery board includes: a sensor that detects the discharging of a fluid from the energy storage apparatus; an opening and closing mechanism that opens and closes the opening enlarged portion; a drive source of the opening and closing mechanism; and a control unit that controls the drive source based on a detection result of the sensor so as to operate the opening and closing mechanism thus adjusting an opening area of the opening enlarged portion.

In the above-mentioned embodiment, the opening enlarged portion 950 that is deformed by receiving a fluid L and enlarges an opening area is exemplified. When a defect occurs in the energy storage device so that a fluid (a gas, a liquid, or a supercritical fluid) having a high temperature is generated, there may be a case where a solid material in the energy storage device is discharged together with the fluid. The opening enlarged portion 950 may be deformed by receiving the momentum of the solid material so as to enlarge an opening area.

In the above-mentioned embodiment, the case has been exemplified where, the opening enlarged portion 950 is disposed at the portion of the housing 901 that opposedly faces the discharge port 601 that forms a portion of the flow path of the energy storage apparatus 1. Alternatively, the entire rear cover 930 of the battery board that opposedly faces the discharge port 601 may be formed using a resin.

The configurations that are formed by arbitrarily combining the respective constitutional elements that the above-mentioned embodiments and the modifications of these embodiments include also fall within the scope of the present invention.

1. A battery board comprising:
an energy storage apparatus that includes: at least one energy storage device having a discharge valve; and a flow path that guides a fluid discharged from the discharge valve of the at least one energy storage device; and
a housing that houses the energy storage apparatus, wherein
an opening enlarged portion that opens or enlarges an opening area by receiving the fluid is provided to a portion of the housing that opposedly faces the flow path.

2. The battery board according to claim 1, wherein
a melting point of the opening enlarged portion is lower than a melting point of a portion of the housing that differs from the opening enlarged portion.

3. The battery board according to claim 1 or 2, wherein
a thickness of the opening enlarged portion is smaller than a thickness of a portion of the housing disposed adjacently to the opening enlarged portion.

4. The battery board according to claim 1, wherein
the opening enlarged portion has an opening mechanism that opens a portion of the housing by receiving the fluid.

5. The battery board according to any one of claims 1 to 4, wherein
at least one opening is formed in the opening enlarged portion.

6. The battery board according to any one of claims 1 to 5, wherein
a plurality of the energy storage apparatuses are accommodated in the housing, and
the opening enlarged portion is provided to each of portions of the housing that opposedly faces flow paths of the plurality of energy storage apparatuses.

7. The battery board according to claim 6, wherein
a plurality of the opening enlarged portions are provided on a one-to-one basis with respect to the flow paths of the plurality of energy storage apparatuses.
